(19) United States
(12) Patent Application Publication
(10) Pub. No.: US 2009/0234806 A1
(43) Pub. Date: Sep. 17, 2009

(54) DISPLAYING SEARCH RESULTS USING SOFTWARE DEVELOPMENT PROCESS INFORMATION

(75) Inventors: Sandra K. Johnson, Cary, NC (US); Sampath K. Chilukuri, Bangalore (IN); Benjamin J. Stoor, Bolingbrook, IL (US); Sharad Mishra, Portland, OR (US); Hemanth G. Kumar, Bangalore (IN); Darbha V. Kumar, Bangalore (IN); Anil Kumar Thiramdas, Anhara Pradesh (IN)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/047,879

(22) Filed: Mar. 13, 2008

(51) Int. Cl. G06F 17/30

(52) U.S. Cl. 707/3; 707/E17.014

(57) ABSTRACT

Embodiments of the present invention address deficiencies of the art with respect to data searching. In one embodiment of the invention, a method for displaying search results from a search on a plurality of repositories storing software development data can be provided. The method can include receiving a plurality of search results produced by a search of the plurality of repositories, wherein each search result includes metadata comprising software development process data including a timestamp. The method can further include reading the metadata from each of the plurality of search results and arranging the plurality of search results in chronological order according to the timestamp in the metadata for each search result.

### BACKGROUND OF THE INVENTION

1. Field of the Invention

The present invention relates to the field of data searching and more particularly relates to the field of searching multiple software development repositories.

2. Description of the Related Art

Knowledge repositories used in software development include various types of information, including source code files, linked libraries, such as graphics libraries, object code files, executable files, media files and the like. Often, a user desires to find certain information in the above software development knowledge repositories. Due to the vast number of software development knowledge repositories and entries in those repositories, many entries have a redundancy of information or share a strong likeness in either function or description. The vastness of the software development knowledge repositories causes users to rely primarily on conventional search applications to retrieve information from the repositories. These search applications use various means to determine the relevance of a user-defined search to the information retrieved.

A typical search application that searches a software development knowledge repository has an interface with a search window where the user enters an alphanumeric search expression or keywords. The search application searches through available entries for the search terms, and returns results in the form of a list of search results. Each search result comprises a list of individual entries that have been identified by the search engine as satisfying the search expression. Each entry or “hit” may comprise a hyperlink that points to a location of the entry.

Search applications of this type typically face a problem with having too many results that contain the query terms. The problem of searching multiple software development knowledge repositories, each having innumerable entries, becomes one of ranking the many results by their importance and relevance to the query, so that the user need not peruse all of the results to satisfy an informational need.

Therefore, there is a need for improvements over the prior art, and more particularly there is a need for a more efficient way of displaying search results for a search on multiple software development repositories.

### BRIEF SUMMARY OF THE INVENTION

Embodiments of the present invention address deficiencies of the art with respect to data searching. In one embodiment of the invention, a method for displaying search results from a search on a plurality of repositories storing software development data can be provided. The method can include receiving a plurality of search results produced by a search of the plurality of repositories, wherein each search result includes metadata comprising software development process data including a timestamp. The method can further include reading the metadata from each of the plurality of search results and arranging the plurality of search results in chronological order according to the timestamp in the metadata for each search result.

In another embodiment of the invention, an alternative method for displaying search results from a search on a plurality of repositories storing software development data can be provided. The method can include receiving a plurality of search results produced by a search of the plurality of repositories, wherein each search result includes metadata comprising software development process data including a text string. The method can further include reading the metadata from each of the plurality of search results and arranging the plurality of search results in alphabetical order according to the text string in the metadata for each search result.

In another embodiment of the invention, a computer program product comprising a computer usable medium embodying computer usable program code for displaying search results from a search on a plurality of repositories storing software development data can be provided. The computer program product can include computer usable program code for receiving a plurality of search results produced by a search of the plurality of repositories, wherein each search result includes metadata comprising software development process data including a timestamp. The computer program product can further include computer usable program code for reading the metadata from each of the plurality of search results and arranging the plurality of search results in chronological order according to the timestamp in the metadata for each search result.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an illustration of a block diagram showing the network architecture of an application in accordance with the principles of the present invention;

FIG. 2 is a flow chart depicting the control flow of the search result display, according to one embodiment of the present invention.

### DETAILED DESCRIPTION OF THE INVENTION

Embodiments of the present invention address deficiencies of the art with respect to data searching of a plurality of repositories storing software development data.

The present invention receives a plurality of search results produced by a search of the plurality of repositories, wherein each search result includes metadata comprising software development process data. Various types of information may comprise software development process data, such as a timestamp, an owner name and a link to another data unit. The present invention reads the metadata from each of the plurality of search results and arranges the plurality of search results in an order defined by a search result display model. If a timestamp is solely defined by the search result display model, then the search results are arranged in chronological order according to the timestamp in the metadata for each search result. If an owner name is solely defined by the search result display model, then the search results are arranged in alphabetical order according to the owner name in the metadata for each search result. If multiple metadata elements are defined by the search result display model, then the search results are arranged in an order combining the multiple metadata elements in the metadata for each search result.

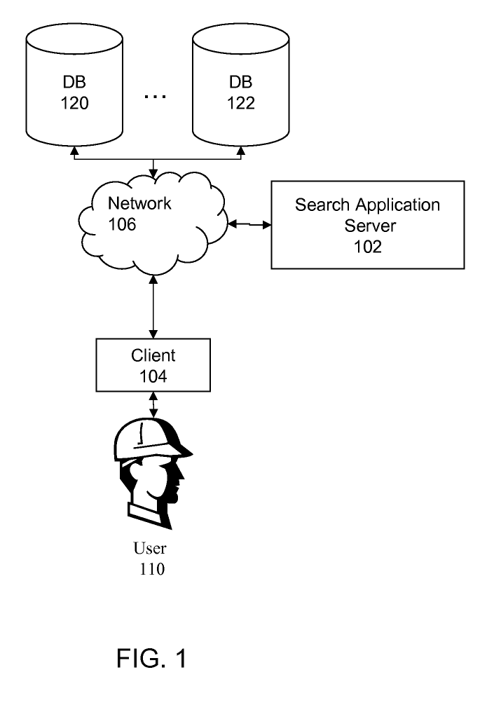

Referring now to the drawing figures in which like reference designators refer to like elements, there is shown in FIG. 1 an illustration of a block diagram showing the network architecture of an application in accordance with the principles of the present invention. The exemplary embodiments of the present invention adhere to the system architecture of FIG. 1. FIG. 1 shows an embodiment of the present invention wherein user 110 utilizes a client computer 104 to interact with search application server 102 over a network 106, such as in an application service provider implementation.

FIG. 1 shows that connected to network 106 is client computer 104, which may comprise, for example, a workstation, a desktop personal computer or a server. The search application server 102 may serve to multiple users a search application that searches multiple software development knowledge repositories, as described in greater detail below. Search application server 102 may be any commercially available server, such as the IBM eServer xSeries server. It should be noted that although FIG. 1 shows only one client computer 104 and one search application server 102, the system of the present invention supports any number of client computers and servers connected to the network 106.

In one embodiment of the present invention, the search application of search application server 102 is a client-server application having a client portion that resides on the computer 104 and a server application that resides on search application server 102. In another embodiment of the present invention, the client portion of the application of search application server 102 that resides on the computer 104 is simply a web browser.

FIG. 1 further shows databases 120, 122 connected to network 106. The databases 120, 122 are a repository for data used during the course of software development. The data stored in databases 120, 122 is described in greater detail below. The databases 120, 122 may adhere to any one of the flat model, hierarchical model, object-oriented model or a relational model for databases. Further, the databases 120, 122 can be any commercially available database, such as an IBM DB2 database server. In another embodiment of the present invention, the databases 120, 122 are connected directly to the search application server 102 and/or client 104.

The databases 120, 122 may also include a database management system, which is an application that controls the organization, storage and retrieval of data (fields, records and files) in a database. A database management system accepts requests for data from a server and instructs the operating system to transfer the appropriate data. A database management system may also control the security and integrity of a database. Data security prevents unauthorized users from viewing or updating certain portions of a database.

In an embodiment of the present invention, the network 106 is a circuit switched network, such as the Public Service Telephone Network (PSTN). In another embodiment, the network 106 is a packet switched network. The packet switched network is a wide area network (WAN), such as the global Internet, a private WAN, a local area network (LAN), a telecommunications network or any combination of the above-mentioned networks. In yet another embodiment, the structure of the network 106 is a wired network, a wireless network, a broadcast network or a point-to-point network.

With respect to the data stored in the software development knowledge repositories 120, 122, during the course of software development, various types of files and information are utilized and/or produced. Source code files, make files, library files, media files, object files, executable files, user's manuals, software design documents, performance files, and the like are example of files that are utilized and/or produced during the course of software development. These files are stored as entries in the software development knowledge repositories 120, 122.

Metadata is usually associated with entries stored in the software development knowledge repositories 120, 122. One example of metadata that may be associated with an entry is a repository data structure that stores information pertaining to an entry in a repository. A repository data structure may include the following data:

the name of the repository

a pointer (such as a URL) to the repository

the name of the owner of the repository

an access control list the defines access for a list of users of the repository

a description of the repository

a type of repository (database, web page, etc.)

history information of the repository

version of the repository

solution support history of the repository

component support history of the repository

an indicator of the lifecycle phase of the repository (development, test, etc.)

a pointer to other related metadata

Another example of metadata that may be associated with an entry or a subset of an entry (such as a data structure or a member of a data structure) is an access data structure that stores information pertaining to an access action that occurred to an entry in a repository. An access data structure may include the following data:

a unique identifier for an entry

a timestamp

a unique identifier of a user that performed the access action

an access type identifier (such as create, modify, delete)

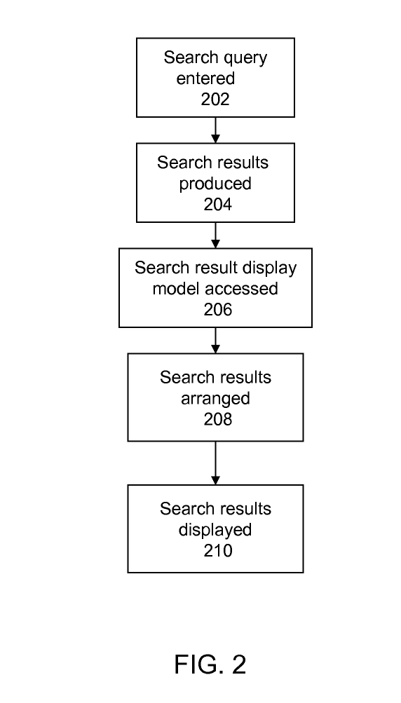

FIG. 2 is a flow chart depicting the control flow of the search result display process, according to one embodiment of the present invention. The flowchart of FIG. 2 describes the process effectuated by search application server 102 of FIG. 1, so as to facilitate the search and display of entries in software development repositories. In another embodiment of the present invention, the flowchart of FIG. 2 describes the process effectuated by a client computer 104 of FIG. 1.

In a first step 202, user 110, utilizing client computer 104, enters a search query that is received by search application server 102. In step 204, the search application server 102 effectuates a search of the software development knowledge repositories 120, 122 using the search query defined by the user 110 and produces a plurality or list of search results comprising entries in the software development knowledge repositories 120, 122.

In step 206, the search application server 102 accesses a search result display model, which defines the method in which search results shall be displayed. In one embodiment of the present invention, the search result display model defines one or more metadata elements that dictate the order in which search results shall be displayed. The manner in which the search result display model defines the method in which search results are displayed is defined in greater detail below.

In step 208, the search application server 102 arranges the search results in an order defined by search result display model accessed in step 204 above. As described above, the search result display model defines one or more metadata elements that dictate the order in which search results shall be displayed. For example, the search result display model may define the “timestamp” metadata element of the access data structure. In this example, the search results are displayed in chronological order according to the “timestamp” metadata element of the access data structure. In another example, the search result display model may define the “owner” metadata element of the repository data structure. In this example, the search results are displayed in alphabetical order according to the “owner” metadata element of the repository data structure.

In one alternative, the search result display model may define more than one metadata element that defines how search results are displayed. In this alternative, the search results are first ordered according to the first metadata element defined, and subsequently the search results are ordered according to the second metadata element defined, and so on and so forth. For example, the search result display model may firstly define the “owner” metadata element of the repository data structure and secondly define the “timestamp” metadata element of the access data structure. In this example, the search results are first arranged in alphabetical order according to the “owner” metadata element of the repository data structure. Then, for each grouping of entries for one owner, the search results in each grouping are arranged in chronological order according to the “timestamp” metadata element of the access data structure.

In another alternative, the search result display model may define more than one metadata elements that are combined so as to define how search results are displayed. In this alternative, the search results are first ordered according to the first metadata element defined and a ranking is garnered for each entry. Separately the search results are ordered according to the second metadata element defined and a ranking is garnered for each entry. Then, an average ranking is reached for each entry, wherein the average is a combination of the rankings garnered for each entry according to the multiple metadata elements. Finally, the search results are arranged according to their average rankings.

For example, the search result display model may define the “owner” metadata element of the repository data structure and further define the “timestamp” metadata element of the access data structure. In this example, the search results are first arranged in alphabetical order according to the “owner” metadata element of the repository data structure. A first ranking is garnered for each search result according to the first arrangement. Then, as a separate matter, the search results are secondly arranged in chronological order according to the “timestamp” metadata element of the access data structure. A second ranking is garnered for each search result according to the second arrangement. Lastly, an average ranking is calculated for each search result, wherein the average ranking averages the first ranking and the second ranking. Finally, the search results are arranged according to their average rankings.

In step 210, the search application server 102 displays the search results as arranged in step 208 above.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a RAM, a ROM, a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for displaying search results from a search on a plurality of repositories storing software development data, comprising:
receiving a plurality of search results produced by a search of the plurality of repositories, wherein each search result includes metadata comprising software development process data including a timestamp;
reading the metadata from each of the plurality of search results; and
arranging the plurality of search results in chronological order according to the timestamp in the metadata for each search result.

2. The method of claim 1, further comprising:
displaying the plurality of search results in chronological order according to the timestamp in the metadata for each search result.

3. The method of claim 2, wherein the step of receiving further comprises:
receiving the plurality of search results produced by a search of the plurality of repositories, wherein each search result includes metadata comprising software development process data further including an owner of a repository in which the search result is stored.

4. The method of claim 3, wherein the step of arranging further comprises:
arranging the plurality of search results in both chronological order according to the timestamp in the metadata for each search result and alphabetical order according to the owner in the metadata for each search result.

5. The method of claim 4, wherein the step of displaying further comprises:
displaying the plurality of search results in both chronological order according to the timestamp in the metadata for each search result and alphabetical order according to the owner in the metadata for each search result.

6. The method of claim 2, wherein the step of receiving further comprises:
receiving the plurality of search results produced by a search of the plurality of repositories, wherein each search result includes metadata comprising software development process data further including a pointer to a repository.

7. The method of claim 6, wherein the step of arranging further comprises:
arranging the plurality of search results in both chronological order according to the timestamp in the metadata for each search result and categorical order according to the pointer in the metadata for each search result.

8. The method of claim 7, wherein the step of displaying further comprises:
displaying the plurality of search results in both chronological order according to the timestamp in the metadata for each search result and categorical order according to the pointer in the metadata for each search result.

9. A method for displaying search results from a search on a plurality of repositories storing software development data, comprising:
receiving a plurality of search results produced by a search of the plurality of repositories, wherein each search result includes metadata comprising software development process data including a text string;
reading the metadata from each of the plurality of search results; and
arranging the plurality of search results in alphabetical order according to the text string in the metadata for each search result.

10. The method of claim 9, further comprising:
displaying the plurality of search results in chronological order according to the text string in the metadata for each search result.

11. The method of claim 10, wherein the step of receiving further comprises:
receiving the plurality of search results produced by a search of the plurality of repositories, wherein each search result includes metadata comprising software development process data further including a time stamp.

12. The method of claim 11, wherein the step of arranging further comprises:
arranging the plurality of search results in both alphabetical order according to the text string in the metadata for each search result and chronological order according to the timestamp in the metadata for each search result.

13. The method of claim 12, wherein the step of displaying further comprises:
displaying the plurality of search results in both alphabetical order according to the text string in the metadata for each search result and chronological order according to the timestamp in the metadata for each search result.

14. A computer program product comprising a computer usable medium embodying computer usable program code for displaying search results from a search on a plurality of repositories storing software development data, comprising:
computer usable program code for receiving a plurality of search results produced by a search of the plurality of repositories, wherein each search result includes metadata comprising software development process data including a timestamp;
computer usable program code for reading the metadata from each of the plurality of search results; and
computer usable program code for arranging the plurality of search results in chronological order according to the timestamp in the metadata for each search result.

15. The computer program product of claim 14, further comprising:
computer usable program code for displaying the plurality of search results in chronological order according to the timestamp in the metadata for each search result.

16. The computer program product of claim 15, wherein the computer usable program code for receiving further comprises:
computer usable program code for receiving the plurality of search results produced by a search of the plurality of repositories, wherein each search result includes metadata comprising software development process data further including an owner of a repository in which the search result is stored.

17. The computer program product of claim 16, wherein the computer usable program code for arranging further comprises:
arranging the plurality of search results in both chronological order according to the timestamp in the metadata for each search result and alphabetical order according to the owner in the metadata for each search result.

18. The computer program product of claim 17, wherein the computer usable program code for displaying further comprises:
computer usable program code for displaying the plurality of search results in both chronological order according to the timestamp in the metadata for each search result and alphabetical order according to the owner in the metadata for each search result.

19. The computer program product of claim 15, wherein the computer usable program code for receiving further comprises:
computer usable program code for receiving the plurality of search results produced by a search of the plurality of repositories, wherein each search result includes metadata comprising software development process data further including a pointer to a repository.

20. The computer program product of claim 19, wherein the computer usable program code for arranging further comprises:
computer usable program code for arranging the plurality of search results in both chronological order according to the timestamp in the metadata for each search result and categorical order according to the pointer in the metadata for each search result.
